(19) United States
(12) Patent Application Publication
(10) Pub. No.: US 2014/0303796 A1
(43) Pub. Date: Oct. 9, 2014

(54) APPARATUS AND METHOD FOR CONTROLLING BUILDING ENERGY

(71) Applicant: ELECTRONICS AND TELECOMMUNICATIONS RESEARCH INSTITUTE, Daejeon (KR)

(72) Inventors: Youn Kwae JEONG, Daejeon (KR); JINSOO HAN, Daejeon (KR); Jong Won KIM, Daejeon (KR); Hyun Jeong LEE, Daejeon (KR); Hyun Jin YOON, Daejeon (KR); IL Woo LEE, Daejeon (KR)

(73) Assignee: ELECTRONICS AND TELECOMMUNICATIONS RESEARCH INSTITUTE, Daejeon (KR)

(21) Appl. No.: 14/011,005

(22) Filed: Aug. 27, 2013

(30) Foreign Application Priority Data
Apr. 5, 2013 (KR) 10-2013-0037374

(51) Int. Cl. G06Q 50/06; G06F 17/30

(52) U.S. Cl. CPC G06Q 50/06; G06F 17/30286
USPC 700/291

(57) ABSTRACT

An apparatus for providing a building energy consumption diagnosis and a real-time commissioning processing, includes a database section configured to store building related information; a real-time commissioning section configured to diagnose energy efficiency and obstruction of the mechanical facilities using the building related information. Further, the apparatus includes a building energy consumption information analysis section configured to determine an energy consumption references and diagnose energy consumption of the buildings to be commissioned using the building related information, the real-time operation information and the measured information on the basis of the determined energy consumption reference.

### CROSS-REFERENCE TO RELATED APPLICATION(S)

The present invention claims priority of Korean Patent Application No. 10-2013-0037374, filed on Apr. 5, 2013, which is incorporated herein by reference.

### FIELD OF THE INVENTION

The present invention relates to an apparatus and method for controlling a building energy, and more particularly, to an apparatus and method for controlling a building energy, capable of continuously collecting energy consumption information with respect to facilities and equipments of a building to perform a consumption diagnosis and a real-time commissioning processing in order to continuously manage an energy efficiency of the building.

### BACKGROUND OF THE INVENTION

In the art, in order to improve energy efficiency of a building, diagnosis is performed on mechanical facilities of a building such as air conditioning, heating, and air handling by a government guideline at a predetermined interval (every 5 years). For example, an off line energy diagnosis method is applied in which energy use amount is measured in a building directly using a variety of measuring instruments based on a checking table prescribed and energy efficiency is intermittently diagnosed by an energy diagnosis expert on the basis of the information measured.

Such method is a one-time diagnostic technology with which a few experts draw an energy saving measurement at a high cost, and mechanical facilities may have problems for a long time or may be operated at low energy efficiency, thereby causing an energy waste in a building.

Further, since a manual diagnosis is directly performed by an expert on the spot for each building, the cost of the diagnosis is high and its maintenance also is difficult.

### SUMMARY OF THE INVENTION

In view of the above, the present invention provides an apparatus and method for controlling a building energy, capable of continuously collecting energy consumption information with respect to facilities and equipments of a building to perform a consumption diagnosis and a real-time commissioning processing in order to continuously manage an energy efficiency of the building, thereby suggesting a measurement for an energy efficiency improvement and verifying an energy reduction effect through a simulation.

In accordance with a first aspect of the present invention, there is provided an apparatus for providing a building energy consumption diagnosis and a real-time commissioning processing. The apparatus includes a database section configured to store building related information including a building energy model, a commissioning model and a building information modeling data for a building energy consumption diagnosis and real-time commissioning; a real-time commissioning section configured, when real-time operational information on mechanical facilities of a building to be commissioned and measured information of measuring instruments are received, to diagnose energy efficiency and obstruction of the mechanical facilities using the building related information; and a building energy consumption information analysis section configured to determine an energy consumption references according to form, type or use of a plurality of buildings on the basis of the amount of energy of the buildings, and diagnose energy consumption of the buildings to be commissioned using the building related information, the real-time operation information and the measured information on the basis of the determined energy consumption reference.

Further, the real-time commissioning section may comprise a commissioning data management unit configured to obtain the commissioning model, facility operation information, energy consumption information, measuring instrument information and building profile information from the database; a facility performance diagnosis unit configured to analyze energy consumption waste factors and energy efficiencies of mechanical facilities on the basis of the commissioning model; an improvement effect prediction unit configured to analyze an improvement effect with respect to the problems about the energy consumption waste factors and the energy efficiencies; and an improvement measurement generation unit configured to derive an improvement measurement having the improvement effect.

Further, the consumption information analysis section may comprise a consumption information analysis data management unit configured to obtain the commissioning model, facility operation information, energy consumption amount information, measuring instrument information, building profile and individual building energy consumption information from the database section; a consumption information statistical analysis unit configured to prepare the energy consumption reference according to form, type or use of the buildings on the basis of energy consumption amount information on the buildings, and diagnose an energy consumption of the building to be commissioned; an energy consumption benchmarking unit configured to perform an energy consumption benchmarking for a building to be commissioned; and an improvement measurement generation unit configured to derive an improvement measurement through the energy consumption benchmarking.

Further, the apparatus may further comprise an improvement measurement effect analysis section configured to store the building improvement measurement derived through the energy consumption diagnosis and analyze an effect of each improvement measurement through an energy simulation before the improvement measurement is applied to the mechanical facilities.

Further, the improvement measurement effect analysis section may comprise an improvement measurement analysis data management unit configured to obtain the building energy model, the commissioning model, an improvement measurement, facility operation information, energy consumption amount information, measuring instrument information and building profile information from the database section; a building energy simulation unit configured to simulate and analyze an energy consumption for the improvement measurement on the basis of the building energy model; an improvement effect analysis unit configured to analyze an improvement effect of the improvement measurement on the basis of a result of the simulation; and

an improvement effect reporting unit configured to provide the improvement effect that is derived as a report.

Further, the apparatus of may further comprise an improvement measurement application section configured to provide a plan of the application measurement for the mechanical facilities with respect to an applicable improvement measurement through an effectiveness analysis by the improvement measurement effect analysis section.

Further, the improvement measurement application section may comprise an improvement measurement application data management unit configured to obtain the improvement measurement, the commissioning model, the facility operation information, the energy consumption amount information, the measuring instrument information and the building profile from the database section; an improvement measurement effect analysis unit configured to analyze a profitability required to perform a business of Energy Service Company (ESCO) with respect to the improvement measurement; and an improvement measurement application reporting unit configured to generate a report for an improvement task of the mechanical facilities.

Further, the apparatus may further comprise an improvement measurement verification section configured to apply (retrofit) the improvement measurement to the building to be commissioned and automatically verify energy reduction effects made before and after applying (retrofitting) the improvement measurement to the building.

Further, the improvement measurement verification section may comprise an improvement measurement verification data management unit configured to obtain an improvement measurement effect verification model, an improvement measurement, a building energy model, a commissioning model, a facility operation information, an energy consumption amount information, measuring instrument information and a building profile from the database section; an energy reduction amount verification unit configured to automatically analyze and verify an energy reduction amount made before and after applying the improvement measurement;

a cost-effective profitability analysis unit configured to analyze a profitability of a cost-effectiveness based on the energy reduction amount; a verification evaluation reporting unit configured to generate a result report for an application effect verification of the improvement measurement; and a verification evaluation visualization unit configured to provide a user screen interface so as to present the contents of the result report to a manager.

Further, the apparatus may further comprise a commissioning group management section configured to generate and manage a variety of services provided in relation to the building to be commissioned.

Further, the commissioning group management section may comprise a retrofit business model unit configured to provide a business model according to an improvement measurement for the mechanical facilities as a function to be provided to a manager; an ESCO (Energy Service Company) business model unit configured to provide a business model needed for an energy efficiency improvement business of the building to be commissioned by the ESCO; a building energy integrated management interlocking unit configured to interlock with a national building energy integrated management database so as to use building energy information constructed and used by a nation in the building to be commissioned; a real-time commissioning service unit configured to provide a real-time commissioning service according to a requirement of a user who uses energy in relation to the building to be commissioned; an energy consumption diagnosis statistical analysis unit configured to provide an energy efficiency diagnosis service through consumption diagnosis and statistical analysis for the mechanical facilities based on a building energy benchmarking; a commissioning infrastructure construction unit configured to provide tools with which the ESCO and the energy user can construct a commissioning infrastructure; and a service framework unit configured to provide a tool used to generate and manage a variety of services that are provided in relation with the building to be commissioned.

Further, the apparatus may further comprise a commissioning infrastructure construction section configured to automatically construct a real-time commissioning infrastructure environment through an optimal arrangement and a profitability analysis of the measuring instruments with respect to each building based on a building information modeling (BIM).

Further, the commissioning infrastructure construction section may comprise a building information modeling data management unit configured to obtain a building profile and a BIM based building information from the database; a commissioning measurement optimal arrangement unit configured to arrange the measuring instruments on the basis of a building structure by the building profile and BIM based building information and a property of the measuring instrument; a commissioning infrastructure construction automatization unit configured to automatically construct an infrastructure for the commissioning based on an optimal arrangement algorithm; a measurement infrastructure construction profitability analysis unit configured to analyze a requirement of a user and a profitability of the measuring instruments; and a measurement infrastructure construction reporting unit configured to provide a specification to install the measuring instruments and construct an infrastructure.

In accordance with a second aspect of the present invention, there is provided a method for providing a building energy consumption diagnosis and a real-time commissioning processing. The method includes collecting facility operation information and energy use amount and building environment information from mechanical facilities and measuring instruments of a building to be commissioned; diagnosing, when real-time operational information on mechanical facilities and measured information of measuring instruments of a building to be commissioned are received, energy efficiencies and obstructions of the mechanical facilities using the building related information; and determining an energy consumption reference according to form, type or use of a building on the basis of energy consumption mount of a plurality of buildings, and diagnosing energy consumption of the building to be commissioned using the building related information, the real-time operation information and the measured information on the basis of the determined energy consumption reference.

Further, the method may further comprise storing an improvement measurement for each building derived through the energy consumption diagnosis, and analyzing an effect of each improvement measurement, which is made before the improvement measurement is applied to the mechanical facilities, through an energy simulation.

Further, the method may further comprise providing a plan of the application measurement for the mechanical facilities through an effectiveness analysis of the improvement measurement with respect to an applicable improvement measurement.

Further, the method of may further comprise applying the improvement measurement to the building to be commissioned; and automatically verifying energy reduction effects made before and after applying (retrofitting) the improvement measurement to the building to be commissioned.

In accordance with the present invention, it is possible to continuously diagnose an operating efficiency of a facility by collecting and measuring real-time energy consumption information and operation data, draw an improvement measurement and an energy reduction measurement and systemize and automize an effect verification process for those or the like at a building operation stage. So a remote group management for a number of buildings can be made through a continuous real-time building energy consumption diagnosis and real-time commissioning for a number of buildings and an operating efficiency of the mechanical facility can be optimally managed. Therefore, it is possible to obtain an elongated life cycle of the mechanical facility and an additional reduction of maintenance costs as well as a continuous energy reduction effect.

Accordingly, in order to continuously enhance an energy performance and facility efficiency of the mechanical facilities of a building, a real-time energy diagnosis is performed through real-time measuring, monitoring, analysis, diagnosis, reduction measurement derivation and verification of building energy consumption amount and operation state, thereby recognizing failure and obstruction in the mechanical facility in a real time, deriving an improvement, improving an energy efficiency and reducing an energy consumption of the building.

### BRIEF DESCRIPTION OF THE DRAWINGS

The above and other objects and features of the present invention will become apparent from the following description of the embodiments given in conjunction with the accompanying drawings, in which:

FIG. 1 is a configuration diagram of a system for providing a building energy consumption diagnosis and real-time commissioning processing including a building energy controlling apparatus in accordance with an embodiment of the present invention;

FIG. 2 is a detailed block diagram of an open gateway that constitutes a system for providing a building energy consumption diagnosis and real-time commissioning processing in accordance with an embodiment of the present invention;

FIG. 3 is a detailed block diagram of a building energy controlling apparatus that constitutes a system for providing a building energy consumption diagnosis and real-time commissioning processing in accordance with an embodiment of the present invention;

FIG. 4 is a detailed block diagram of a real-time commissioning section that constitutes a building energy controlling apparatus in accordance with an embodiment of the present invention;

FIG. 5 is a detailed block diagram of an improvement measurement effect analysis section that constitutes a building energy controlling apparatus in accordance with an embodiment of the present invention;

FIG. 6 is a detailed block diagram of an improvement measurement effect analysis section that constitutes a building energy controlling apparatus in accordance with an embodiment of the present invention;

FIG. 7 is a detailed block diagram of an improvement measurement application section that constitutes a building energy controlling apparatus in accordance with an embodiment of the present invention;

FIG. 8 is a detailed block diagram of an improvement measurement verification section that constitutes a building energy controlling apparatus in accordance with an embodiment of the present invention;

FIG. 9 is a detailed block diagram of a commissioning group management section that constitutes a building energy controlling apparatus in accordance with an embodiment of the present invention;

FIG. 10 is a detailed block diagram of a commissioning infrastructure construction section that constitutes a building energy controlling apparatus in accordance with an embodiment of the present invention; and

FIG. 11 is a flowchart illustrating a method for providing a building energy consumption diagnosis and real-time commissioning processing by a building energy controlling apparatus in accordance with an embodiment of the present invention.

### DETAILED DESCRIPTION OF THE EMBODIMENTS

Hereinafter, embodiments of the present invention will be described in detail with reference to the accompanying drawings.

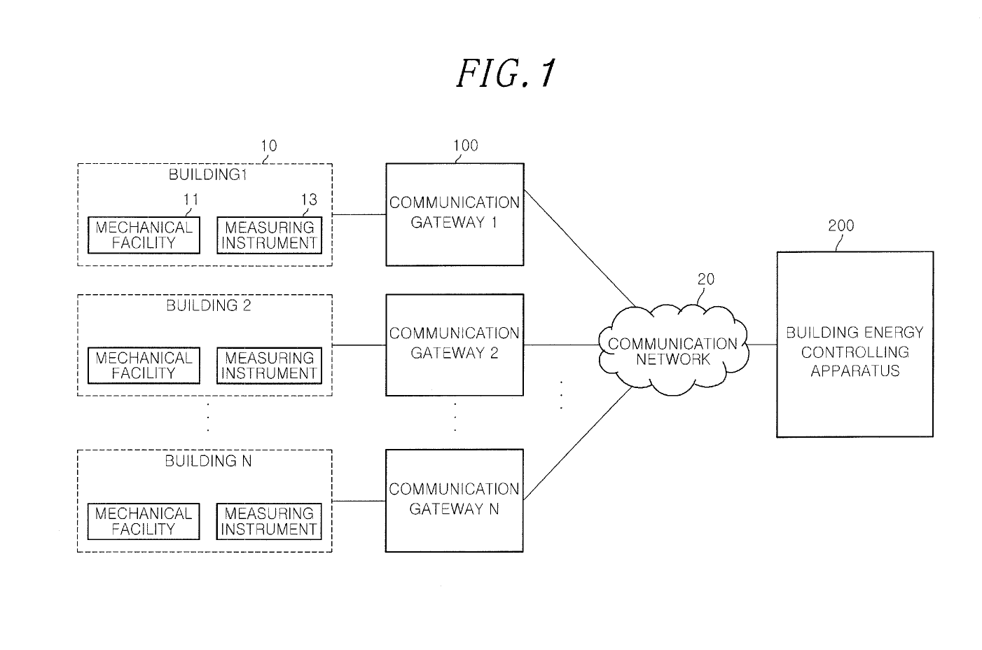

FIG. 1 is a configuration diagram of a system for providing a building energy consumption diagnosis and real-time commissioning processing including a building energy controlling apparatus in accordance with an embodiment of the present invention.

As illustrated in the drawing, a system for providing a building energy consumption diagnosis and real-time commissioning processing includes a plurality of open gateways 100 connected to mechanical facilities 11 and measuring instruments 13 mounted in a plurality of buildings 10, and a building energy controlling apparatus 200 connected to the open gateways 100 through a communication network 20.

The plurality of the open gateways 100 serve to collect operational information and measuring information from the mechanical facilities 11 and the measuring instruments 13 mounted in the plurality of buildings 10 and integrally control the operation information and measuring information.

The building energy controlling apparatus 200 is connected to the open gateways 100 through the communication network 20, and serves to perform a building energy consumption diagnosis and real-time commissioning for the plurality of the buildings 10, systemize processes to continuously manage and improve an energy efficiency of the mechanical facility 11, and reduce an energy consumption of the buildings 10 through atomization.

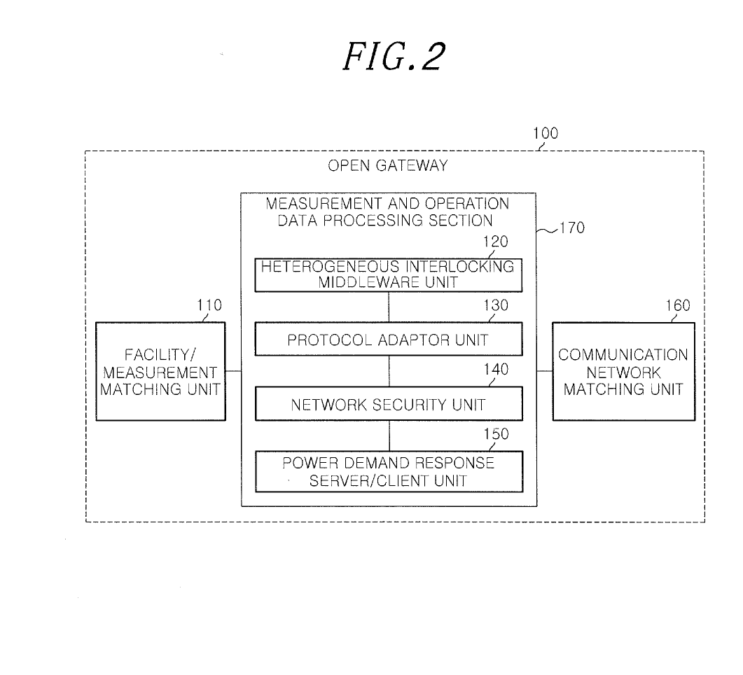

FIG. 2 is a detailed block diagram of an open gateway that constitutes a system for providing a building energy consumption diagnosis and real-time commissioning processing in accordance with an embodiment of the present invention.

As illustrated in the drawing, each of the open gateways 100 includes a facility/measurement matching unit 110, a measurement and operation data processing section 170, and a communication network matching unit 160. Further, the measurement and operation data processing section 170 includes a heterogeneous interlocking middleware unit 120, a protocol adaptor unit 130, a network security unit 140, a power demand response server/client unit 150. The open gateway 100 integrates operation information and energy consumption information of a variety of facilities of the building 10 to make data processing and management easy and performs a safe information exchange with the building energy controlling apparatus 200.

The facility/measurement matching unit 110 matches signals in order to transmit and receive kinds of signals with respect to a variety of mechanical facilities 11 of the building 10 and a measuring instrument 13 such as a sensor and a meter.

The heterogeneous interlocking middleware unit 120 analyses building energy information collected based on a profile of the building 10 and integrally manages information on the heterogeneous facilities.

The protocol adaptor unit 130 integrally controls and manages facilities that use different communication/control protocols such as BACnet, Modbus, KNX, LonWork, etc.

The network security unit 140 provides a communication security used to communicate with the building energy controlling apparatus 200 at a remote location when controlling and managing the facilities of the building 10.

The power demand response server/client unit 150 processes a power demand response function to effectively control power demand of the building 10.

The communication network matching unit 160 matches signals of the communication network 20 such as wired/wireless Internet that is used to communicate with the building energy controlling apparatus 200 at a remote location for controlling a building energy.

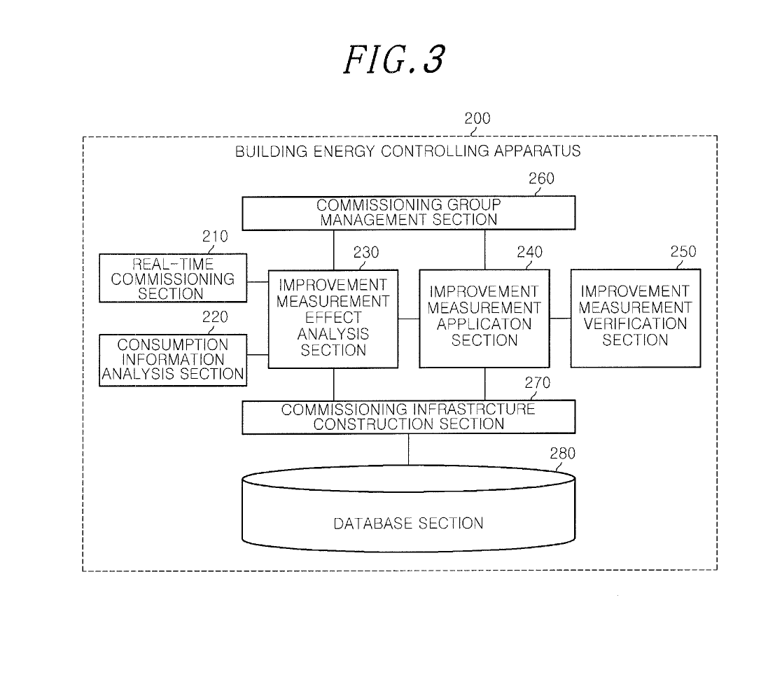

FIG. 3 is a detailed block diagram of a building energy controlling apparatus that constitutes a system for providing a building energy consumption diagnosis and real-time commissioning processing in accordance with an embodiment of the present invention;

As illustrated in the drawing, the building energy controlling apparatus 200 includes a real-time commissioning section 210, a consumption information analysis section 220, an improvement measurement effect analysis section 230, an improvement measurement application section 240, an improvement measurement verification section 250, a commissioning group management section 260, a commissioning infrastructure construction section 270, and a database section 280.

The real-time commissioning section 210 receives real-time operational information about the mechanical facility 11 and measurement information of the measuring instrument 13, diagnoses an energy efficiency and obstruction of the mechanical facility 11 and provides an improvement measurement.

The consumption information analysis section 220 determines an energy consumption reference (obtain) according to form, type or use of the building based on energy consumption amount of a variety of buildings, diagnoses an energy consumption of the building to be commissioned based on such information and provides an improvement measurement.

The improvement measurement effect analysis section 230 stores an improvement measurement for each building derived through the energy consumption diagnosis, and analyzes an effect of each improvement measurement through an energy simulation before applying the improvement measurement to the mechanical facility of the building.

The improvement measurement application section 240 provides a plan of application measurement for the mechanical facility of the building through the analysis effect with respect to applicable improvement measurement.

The improvement measurement verification section 250 automatically verifies energy reduction effects made before and after applying (retrofitting) the improvement measurement to an actual building, the energy reduction effects being verified after the improvement measurement is applied to the actual building.

The commissioning group management section 260 generates and manages a variety of services provided from the building energy controlling apparatus 200.

The commissioning infrastructure construction section 270 automatically constructs a real-time commissioning infrastructure environment with respect to each building through an optimal arrangement and a profitability analysis of different measuring instruments 13 on the basis of a Building Information Modeling (BIM).

The database section 280 includes a building energy model, a commission model, building information modeling data, a building profile database, a facility operation information database, an energy consumption amount information database, a measuring instrument information database, an improvement measurement database, and a facility operational database.

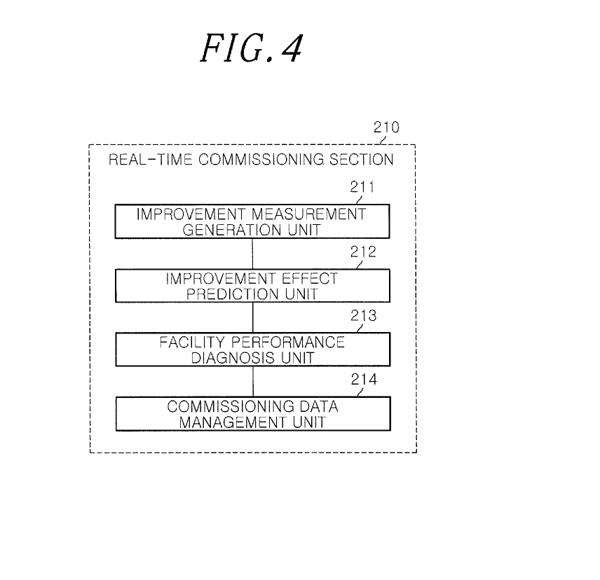

FIG. 4 is a detailed block diagram of a real-time commissioning section that constitutes a building energy controlling apparatus in accordance with an embodiment of the present invention.

As illustrated in the drawing, the real-time commissioning section 210 includes an improvement measurement generation unit 211, an improvement effect prediction unit 212, a facility performance diagnosis unit 213, and a commissioning data management unit 214.

The commissioning data management unit 214 obtains information from a commissioning model, a facility operation information database, an energy consumption amount information database, a measuring instrument information database, a building profile database of the database section 280.

The facility performance diagnosis unit 213 analyzes an energy consumption waste factor and an energy efficiency based on the building commissioning model.

The improvement effect prediction unit 212 analyzes problems about the energy consumption waste factors and the energy efficiency.

The improvement measurement generation unit 211 draws an improvement effect prediction engine, and an improvement measurement that has an improvement effect.

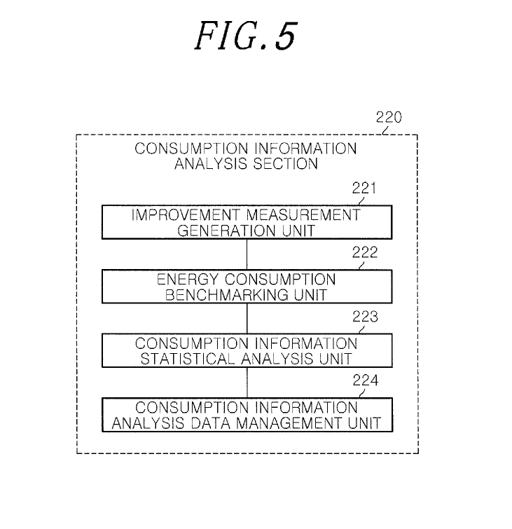

FIG. 5 is a detailed block diagram of an improvement measurement effect analysis section that constitutes a building energy controlling apparatus in accordance with an embodiment of the present invention.

As illustrated in the drawing, the consumption information analysis section 220 includes an improvement measurement generation unit 221, an energy consumption benchmarking unit 222, a consumption information statistical analysis unit 223, and a consumption information analysis data management unit 224.

The consumption information analysis data management unit 224 obtains information from a commissioning model, a facility operation information database, an energy consumption amount information database, a measuring instrument information database, a building profile database, an energy consumption information analysis database such as an individual building energy consumption information database of the database section 280.

The consumption information statistical analysis unit 223 makes the energy consumption reference (baseline) according to form, type or use of the building based on the energy consumption information on different buildings.

The energy consumption benchmarking unit 222 performs an energy consumption benchmarking with respect to a building to be commissioned.

The improvement measurement generation unit 221 draws an improvement measurement through a benchmarking.

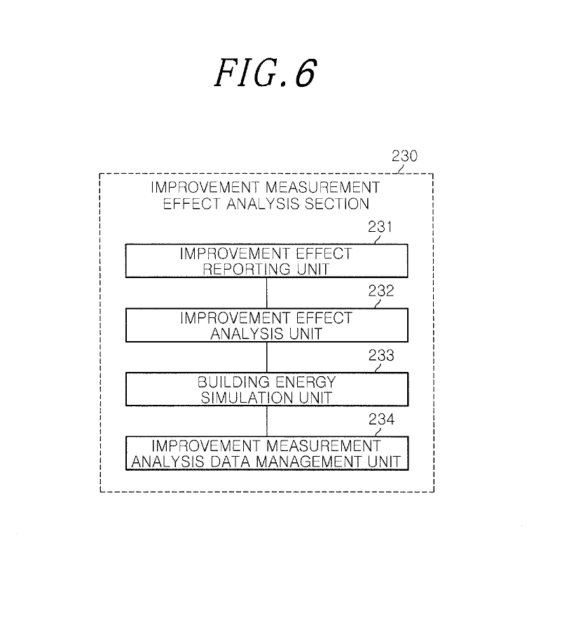

FIG. 6 is a detailed block diagram of an improvement measurement effect analysis section that constitutes a building energy controlling apparatus in accordance with an embodiment of the present invention.

As illustrated in the drawing, the improvement measurement effect analysis section 230 includes an improvement effect reporting unit 231, an improvement effect analysis unit 232, a building energy simulation unit 233, and an improvement measurement analysis data management unit 234. Further, the improvement measurement effect analysis section 230 stores and manages each building improvement measurement derived from a real-time commissioning system and building energy consumption analysis system.

The improvement measurement analysis data management unit 234 obtains a building energy model, a commissioning model, an improvement measurement database, a facility operation information database, an energy consumption amount information database, a measuring instrument information database, a building profile database of the database section 280.

The building energy simulation unit 233 simulates and analyzes an energy consumption using EnergyPlus, ESP-r, TRANSYS with respect to improvement measurements based on the building energy model.

The improvement effect unit 232 analyzes an improvement effect with respect to an improvement effect based on a simulation result.

The improvement effect reporting unit 231 provides a manager with the derived improvement effect as a report.

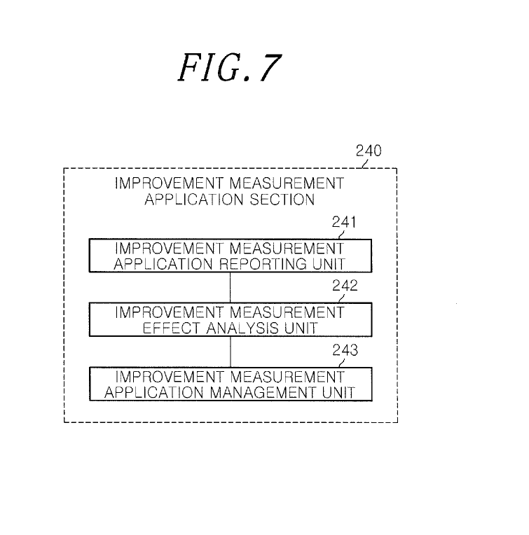

FIG. 7 is a detailed block diagram of an improvement measurement application section that constitutes a building energy controlling apparatus in accordance with an embodiment of the present invention.

As illustrated in the drawing, the improvement measurement application section 240 includes an improvement measurement application reporting unit 241, an improvement measurement effect analysis unit 242, and an improvement measurement application data management unit 243.

The improvement measurement application data management unit 243 obtains information from an improvement measurement database, a commissioning model, a facility operation information database, an energy consumption amount information database, a measuring instrument information database, a building profile database of the database section 280.

The improvement measurement effect analysis unit 242 analyzes a profitability required in a business implementation of Energy Service Companies (ESCO) with respect to each improvement measurement.

The improvement measurement application reporting unit 241 generates a report for an improvement task of an actual mechanical facility.

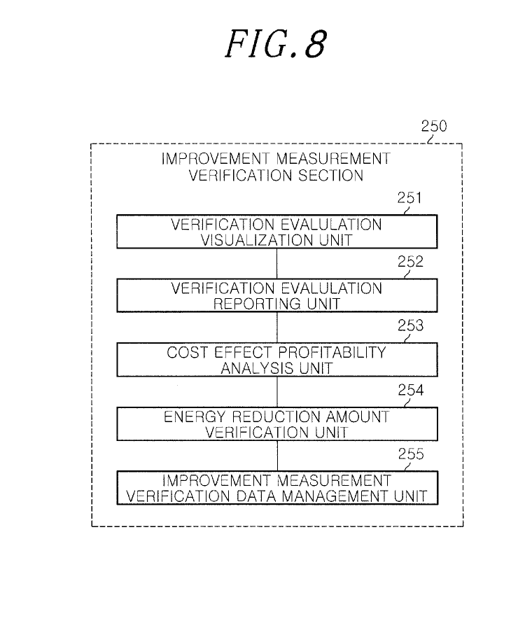

FIG. 8 is a detailed block diagram of an improvement measurement verification section that constitutes a building energy controlling apparatus in accordance with an embodiment of the present invention.

As illustrated in the drawing, the improvement measurement verification section 250 includes a verification evaluation visualization unit 251, a verification evaluation reporting unit 252, a cost-effectiveness profitability analysis unit 253, an energy reduction amount verification unit 254, and an improvement measurement verification data management unit 255.

The improvement measurement verification data management unit 255 obtains information from an improvement measurement effect verification model, an improvement measurement database, a building energy model, a commissioning model, a facility operation information database, an energy consumption amount information database, a measuring instrument information database, and building a profile database of the database section 280.

The energy reduction amount verification unit 254 automatically analyzes and verifies an energy reduction amount made before and after applying the improvement measurement.

The verification evaluation reporting unit 252 analyzes a profitability of cost-effectiveness on a basis of an energy reduction amount.

The verification evaluation reporting unit 252 generates a result report of Measurement and Verification (M&V) on the improvement measurement application effect.

The verification evaluation visualization unit 251 provides a user screen interface in order to effectively suggest report contents to a manager.

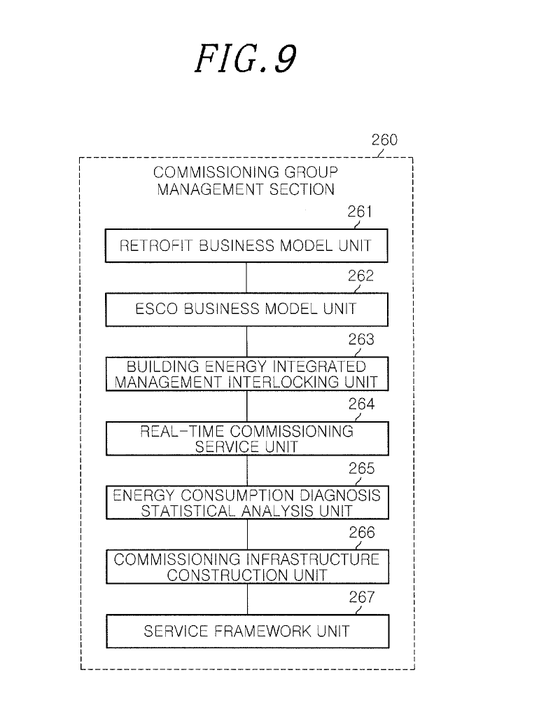

FIG. 9 is a detailed block diagram of a commissioning group management section that constitutes a building energy controlling apparatus in accordance with an embodiment of the present invention;

The commissioning group management section 260 includes a retrofit business model unit 261, an ESCO business model unit 262, a building energy integrated management interlocking unit 263, a real-time commissioning service unit 264, an energy consumption diagnosis statistical analysis unit 265, a commissioning infrastructure construction unit 266, and a service framework unit 267.

The retrofit business modeling unit 261 is provides a business model according to an improvement measurement for a building mechanical facilities that needs to be provided with a manager of a real-time building energy consumption analysis and commissioning control center. The building energy integrated management interlocking unit 263 interlocks with a national building energy integrated management database so as to use building energy information constructed and used by a nation.

The real-time commissioning service unit 264 provides a real-time commissioning service to a user in accordance with a request from an energy consumer (a landlord).

The energy consumption diagnosis statistical analysis unit 265 provides an energy efficiency diagnosis service through consumption diagnostics and statistical analysis of the building mechanical facilities based on the building energy benchmarking.

The commissioning infra construction unit 266 provides tools for constructing an effective commissioning infrastructure to the user and the ESCO operator.

The service framework unit 267 provides a tool for creating and managing a variety of services in the building energy consumption diagnosis and commissioning center.

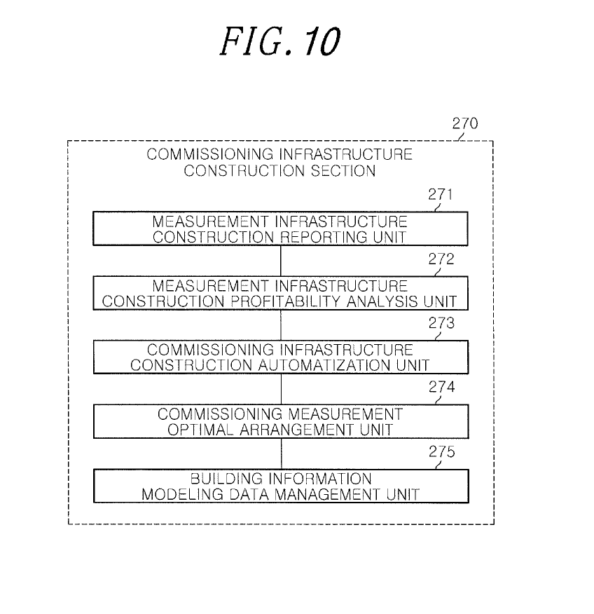

FIG. 10 is a detailed block diagram of a commissioning infrastructure construction section that constitutes a building energy controlling apparatus in accordance with an embodiment of the present invention.

As illustrated in drawing, the commissioning infrastructure construction section 270 includes the measurement infrastructure construction reporting unit 271, the measurement infrastructure profitability analysis unit 272, the commissioning infrastructure construction automatization unit 273, the commissioning measurement optimum arrangement unit 274, and the building information modeling data management unit 275.

The building information modeling data management unit 275 obtains information from a building profile database, a building energy commissioning infrastructure automatic construction database such as an EIM-based building database in the database section 280.

The commissioning measurement optimum arrangement unit 274 optimally arranges a commissioning measuring instrument on a basis of the building structure and the property of measuring instrument such as a sensor/meter.

The commissioning infrastructure construction automatization unit 273 automatically constructs a commissioning infrastructure on a basis of an optimal arrangement algorithm.

The measurement infrastructure economical analysis unit 272 analyzes the user's request and a profitability of the measuring instruments that are optimally arranged.

The measurement infrastructure construction reporting unit 271 provides a specification for arranging the measuring instruments and constructing the infrastructures.

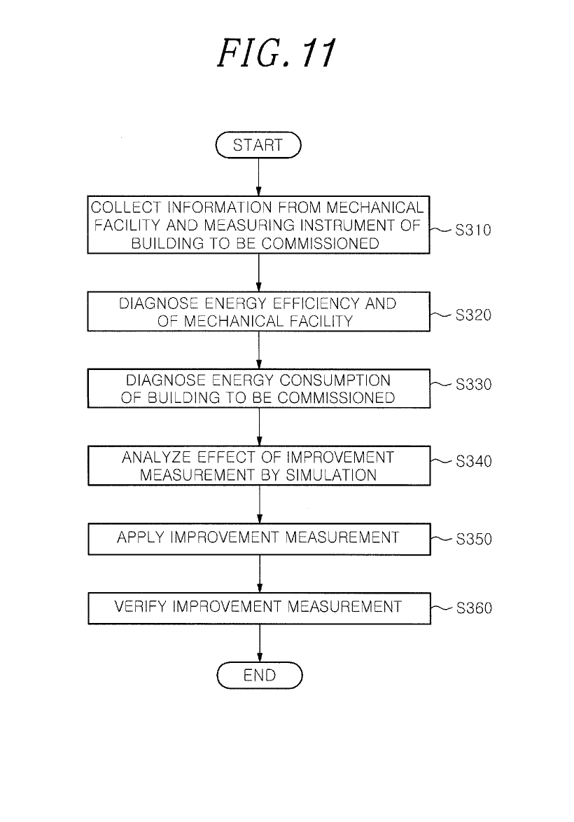

A procedure of performing a consumption diagnosis and a real-time commissioning by the building energy consumption diagnosis and real-time commissioning processing system will be described with reference to FIG. 11.

First, in operation S310, the open gateway 100 collects and stores data through the facility/measurement matching units 110 via a variety of network protocols such as BACnet, Modbus, KNX, LonWork, ZigBee, and the like. That is, the open gateway 100 collects and stores facility operation information, energy use amount, building environment information from the mechanical facilities 11 of the building and commissioning measuring instruments 13 such as sensors and meters.

The protocol adapter unit 130 transforms data received from a variety of network protocols such as Modbus, KNX, LonWork, ZigBee and others into a unified integration protocol. The heterogeneous interlocking middleware unit 120 loads the building profile information having a shape information about the building and compares a building profile information with data that is received from the mechanical facilities 11 and measuring instruments 13 to confirm the accuracy and safety of the data. The network security unit 140 performs a security function to the data that is received and transmitted.

In addition, the network matching unit 160 creates data using a unified standard protocol between the building energy control apparatus 200 and the open gateway 100 and transfers the created data to the building energy control apparatus 200.

Subsequently, the building energy control apparatus 200 stores the facility operational information about the mechanical facilities 11 and the measuring instrument 13 of the building 10, energy consumption amount, building environment information and the like in the database section 280.

In operation S320, the commissioning data management unit 214 in the real-time commissioning section 210 comprised of the building energy control apparatus 200 obtains information from a commissioning model, a facility operation information database, an energy consumption information database, a measuring instrument information database, and a building profile database of the database 280.

The facility performance diagnosis unit 213 in the real-time commissioning section 210 analyzes the energy consumption waste factor and the energy efficiency of mechanical facilities and the like based on the building commissioning model to derive the improvement measurements to the problems about the waste factors and energy efficiency. The improvement efficiency prediction unit 212 analyzes the improvement effect to the problems about the waste factors and energy efficiency, and the improvement measurement creation unit 211 finally draws the improvement measurements with an improvement effect.

Next, in operation S330, the consumption information analysis data management unit 224 in the consumption information analysis section 220 obtains information from a commissioning model, a facility operation information database, an energy consumption amount information database, a measuring instrument information database, a building profile database, a database module 280, and an energy consumption information analysis database such as an individual building energy consumption information database of the database module 280.

The consumption information statistical analysis unit in the consumption information analysis section 220 prepares the energy consumption reference (baseline) according to form, type or use of the buildings on the basis of energy consumption amount information on different buildings and performs the energy consumption benchmarking to the building to be commissioned. The improvement measurement generation unit 221 derives an improvement measurement through the energy consumption benchmarking.

In operation S340, the improvement measurement effect analysis section 230 stores the individual building improvement measurement.

For the purpose of the above, the improvement measurement analysis data management unit 234 in the improvement measurement effect analysis section 230 obtains the building energy model, the commissioning model, an improvement measurement database, facility operation information database, energy consumption amount information database, measuring instrument information database, and building profile database of the database section 280. In addition, the building energy simulation unit 233 simulates and analyzes the energy consumption using EnergyPlus ESP-r, TRANSYS on a basis of the building energy model with respect to the improvement measurements. The improvement effect analysis unit 232 analyzes the improvement effect to the improvement measurements on a basis of the simulation result, and the improvement effect reporting unit 231 reports the derived improvement effect to the manager as a report.

In operation S350, the improvement measurement application data management unit 243 in the improvement measurement application section 240 obtains information from the improvement measurement database, the commissioning model, the facility operation information database, the energy consumption amount information database, the measuring instrument information database, and the building profile database of the database section 280.

The improvement measurement effect analysis unit 242 analyzes a profitability necessary to carry out the business by the ESCO (Energy Service Company), the improvement measurement application reporting unit 241 creates a report for improvement task of the mechanical facilities.

In operation S360, the improvement measurement verification data management unit 255 in the improvement measurement verification section 250 obtains information from the improvement measurement effect verification model, the improvement measurement database, the building energy model, the commissioning model, the facility operation information database, the energy consumption amount information database, the measuring instrument information database, and the building profile database of the database section 280.

In addition, the energy reduction amount verification unit 254 automatically analyzes and verifies the energy reduction amount made before and after applying the improvement measurements, the cost-effectiveness profitability analysis unit 253 analyzes a profitability of a cost-effectiveness on the basis of the energy reduction amount. The verification evaluation reporting unit 252 creates a result report of Measurement and Verification (M&V) on the application effect of the improvement measurement. The verification evaluation visualization unit 251 provides a screen interface with the user to present effectively the report content.

The above processes are run repeatedly continuously in real-time in the building energy control apparatus 200 and the open gateway 100 to perform a real-time measurement, monitoring, analysis, diagnosis, derivation of the saving measurements about the energy consumption and operation status of the building. Therefore, it is possible to improve continuously the energy performance and the facility efficiency and for the mechanical facilities of the buildings through the real-time energy diagnosis, to perceive in real time the failure or malfunction of the mechanical facilities to derive improvements, to improve the energy efficiency to reduce the energy consumption of the building, and to achieve longevity of the mechanical facilities and additional saving of the maintenance costs.

While the invention has been shown and described with respect to the embodiments, the present invention is not limited thereto. It will be understood by those skilled in the art that various changes and modifications may be made without departing from the scope of the invention as defined in the following claims.

What is claimed is:

1. An apparatus for providing a building energy consumption diagnosis and a real-time commissioning processing, the apparatus comprising:
a database section configured to store building related information including a building energy model, a commissioning model and a building information modeling data for a building energy consumption diagnosis and real-time commissioning;
a real-time commissioning section configured, when real-time operational information on mechanical facilities of a building to be commissioned and measured information of measuring instruments are received, to diagnose energy efficiency and obstruction of the mechanical facilities using the building related information; and
a building energy consumption information analysis section configured to determine an energy consumption references according to form, type or use of a plurality of buildings on the basis of the amount of energy of the buildings, and diagnose energy consumption of the buildings to be commissioned using the building related information, the real-time operation information and the measured information on the basis of the determined energy consumption reference.

2. The apparatus of claim 1, wherein the real-time commissioning section comprises:
a commissioning data management unit configured to obtain the commissioning model, facility operation information, energy consumption information, measuring instrument information and building profile information from the database;
a facility performance diagnosis unit configured to analyze energy consumption waste factors and energy efficiencies of mechanical facilities on the basis of the commissioning model;
an improvement effect prediction unit configured to analyze an improvement effect with respect to the problems about the energy consumption waste factors and the energy efficiencies; and
an improvement measurement generation unit configured to derive an improvement measurement having the improvement effect.

3. The apparatus of claim 1, wherein the consumption information analysis section comprises:
a consumption information analysis data management unit configured to obtain the commissioning model, facility operation information, energy consumption amount information, measuring instrument information, building profile and individual building energy consumption information from the database section;
a consumption information statistical analysis unit configured to prepare the energy consumption reference according to form, type or use of the buildings on the basis of energy consumption amount information on the buildings, and diagnose an energy consumption of the building to be commissioned;
an energy consumption benchmarking unit configured to perform an energy consumption benchmarking for a building to be commissioned; and
an improvement measurement generation unit configured to derive an improvement measurement through the energy consumption benchmarking.

4. The apparatus of claim 1, further comprising:
an improvement measurement effect analysis section configured to store the building improvement measurement derived through the energy consumption diagnosis and analyze an effect of each improvement measurement through an energy simulation before the improvement measurement is applied to the mechanical facilities.

5. The apparatus of claim 4, wherein the improvement measurement effect analysis section comprises:
an improvement measurement analysis data management unit configured to obtain the building energy model, the commissioning model, an improvement measurement, facility operation information, energy consumption amount information, measuring instrument information and building profile information from the database section;
a building energy simulation unit configured to simulate and analyze an energy consumption for the improvement measurement on the basis of the building energy model;
an improvement effect analysis unit configured to analyze an improvement effect of the improvement measurement on the basis of a result of the simulation; and
an improvement effect reporting unit configured to provide the improvement effect that is derived as a report.

6. The apparatus of claim 4, further comprising:
an improvement measurement application section configured to provide a plan of the application measurement for the mechanical facilities with respect to an applicable improvement measurement through an effectiveness analysis by the improvement measurement effect analysis section.

7. The apparatus of claim 6, wherein the improvement measurement application section comprises:
an improvement measurement application data management unit configured to obtain the improvement measurement, the commissioning model, the facility operation information, the energy consumption amount information, the measuring instrument information and the building profile from the database section;
an improvement measurement effect analysis unit configured to analyze a profitability required to perform a business of Energy Service Company (ESCO) with respect to the improvement measurement; and
an improvement measurement application reporting unit configured to generate a report for an improvement task of the mechanical facilities.

8. The apparatus of claim 6, further comprising:
an improvement measurement verification section configured to apply (retrofit) the improvement measurement to the building to be commissioned and automatically verify energy reduction effects made before and after applying (retrofitting) the improvement measurement to the building.

9. The apparatus of claim 8, wherein the improvement measurement verification section comprises:
an improvement measurement verification data management unit configured to obtain an improvement measurement effect verification model, an improvement measurement, a building energy model, a commissioning model, a facility operation information, an energy consumption amount information, measuring instrument information and a building profile from the database section;
an energy reduction amount verification unit configured to automatically analyze and verify an energy reduction amount made before and after applying the improvement measurement;
a cost-effective profitability analysis unit configured to analyze a profitability of a cost-effectiveness based on the energy reduction amount;
a verification evaluation reporting unit configured to generate a result report for an application effect verification of the improvement measurement; and
a verification evaluation visualization unit configured to provide a user screen interface so as to present the contents of the result report to a manager.

10. The apparatus of claim 1, further comprising:
a commissioning group management section configured to generate and manage a variety of services provided in relation to the building to be commissioned.

11. The apparatus of claim 10, wherein the commissioning group management section comprises:
a retrofit business model unit configured to provide a business model according to an improvement measurement for the mechanical facilities as a function to be provided to a manager;
an ESCO (Energy Service Company) business model unit configured to provide a business model needed for an energy efficiency improvement business of the building to be commissioned by the ESCO;
a building energy integrated management interlocking unit configured to interlock with a national building energy integrated management database so as to use building energy information constructed and used by a nation in the building to be commissioned;
a real-time commissioning service unit configured to provide a real-time commissioning service according to a requirement of a user who uses energy in relation to the building to be commissioned;
an energy consumption diagnosis statistical analysis unit configured to provide an energy efficiency diagnosis service through consumption diagnosis and statistical analysis for the mechanical facilities based on a building energy benchmarking;
a commissioning infrastructure construction unit configured to provide tools with which the ESCO and the energy user can construct a commissioning infrastructure; and
a service framework unit configured to provide a tool used to generate and manage a variety of services that are provided in relation with the building to be commissioned.

12. The apparatus of claim 1, further comprising:
a commissioning infrastructure construction section configured to automatically construct a real-time commissioning infrastructure environment through an optimal arrangement and a profitability analysis of the measuring instruments with respect to each building based on a building information modeling (BIM).

13. The apparatus of claim 12, wherein the commissioning infrastructure construction section comprises:
a building information modeling data management unit configured to obtain a building profile and a BIM based building information from the database;
a commissioning measurement optimal arrangement unit configured to arrange the measuring instruments on the basis of a building structure by the building profile and BIM based building information and a property of the measuring instrument;
a commissioning infrastructure construction automatization unit configured to automatically construct an infrastructure for the commissioning based on an optimal arrangement algorithm;
a measurement infrastructure construction profitability analysis unit configured to analyze a requirement of a user and a profitability of the measuring instruments; and
a measurement infrastructure construction reporting unit configured to provide a specification to install the measuring instruments and construct an infrastructure.

14. A method for providing a building energy consumption diagnosis and a real-time commissioning processing, the method comprising:
collecting facility operation information and energy use amount and building environment information from mechanical facilities and measuring instruments of a building to be commissioned;
diagnosing, when real-time operational information on mechanical facilities and measured information of measuring instruments of a building to be commissioned are received, energy efficiencies and obstructions of the mechanical facilities using the building related information; and
determining an energy consumption reference according to form, type or use of a building on the basis of energy consumption mount of a plurality of buildings, and diagnosing energy consumption of the building to be commissioned using the building related information, the real-time operation information and the measured information on the basis of the determined energy consumption reference.

15. The method of claim 14, further comprising:
storing an improvement measurement for each building derived through the energy consumption diagnosis, and analyzing an effect of each improvement measurement, which is made before the improvement measurement is applied to the mechanical facilities, through an energy simulation.

16. The method of claim 15, further comprising:
providing a plan of the application measurement for the mechanical facilities through an effectiveness analysis of the improvement measurement with respect to an applicable improvement measurement.

17. The method of claim 15, further comprising:
applying the improvement measurement to the building to be commissioned; and
automatically verifying energy reduction effects made before and after applying (retrofitting) the improvement measurement to the building to be commissioned.
